(19) United States
(12) Patent Application Publication
(10) Pub. No.: US 2011/0176402 A1
(43) Pub. Date: Jul. 21, 2011

(54) FOCUS CONTROL APPARATUS, FOCUS CONTROL METHOD, OPTICAL PICKUP APPARATUS, DRIVE APPARATUS, AND OPTICAL RECORDING MEDIUM

(75) Inventor: Takanobu Higuchi, Saitama (JP)

(73) Assignee: PIONEER CORPORATION, Kanagawa (JP)

(21) Appl. No.: 13/003,918

(22) PCT Filed: Jul. 14, 2008
(86) PCT No.: PCT/JP2008/062692

§ 371 Date: Mar. 3, 2011

(51) Int. Cl. G11B 7/09; G11B 7/24

(52) U.S. Cl. 369/53.23; 369/284; G9B/7.07; G9B/7.168

(57) ABSTRACT

[PROBLEMS] To perform highly accurate focus control in an optical recording medium of multilayer structure having an interface of each layer with a reflectance reduced as much as possible.

[SOLVING ELEMENT] In a focus control apparatus with optical pickup for use in an optical recording medium of multilayer structure, laser light irradiating device including a laser light source (50) and an objective lens (54) irradiates laser light to an optical recording medium (D), a photodetector (55) detects an optical characteristic change associated with multiphoton absorption caused when the laser light is condensed to at least one of recording layers, and in accordance with the detection result, focus control in the optical pickup is performed for an arbitrary recording layer (L1 to Ln).

### TECHNICAL FIELD

The present invention relates to a focus control apparatus, a focus control method, an optical pickup apparatus, and a drive apparatus for use in an optical recording medium, preferably an optical recording medium of multilayer structure, and to that optical recording medium.

### BACKGROUND ART

Optical disks represented by DVDs, CDs, MDs and the like are widely available as optical recording media for recording and reproducing digital data such as moving images and computer applications. The optical disks are broadly classified into optical disks only for reproduction and optical disks for recording and reproduction capable of recording through additional writing or overwriting. Such optical disks are widely used as recording media of removable type having excellent durability and large recording capacity.

With the advancement of information technology in recent years, however, an increase in recording capacity is desired for the optical disk. Multilayering, which includes arranging a plurality of recording layers in a depth direction of a disk, has been pursued as a method of achieving a larger capacity in the optical disk. As regards the optical disks having the multilayer structure, optical disks of two-layer structure have already been commercially practical, and it is expected that optical disks of six to eight layers will be put to practical use in a few years. In addition, although not yet in actual use, optical disks of 100 layers or more can be manufactured at the current technological level (for example, see Patent Document 1).

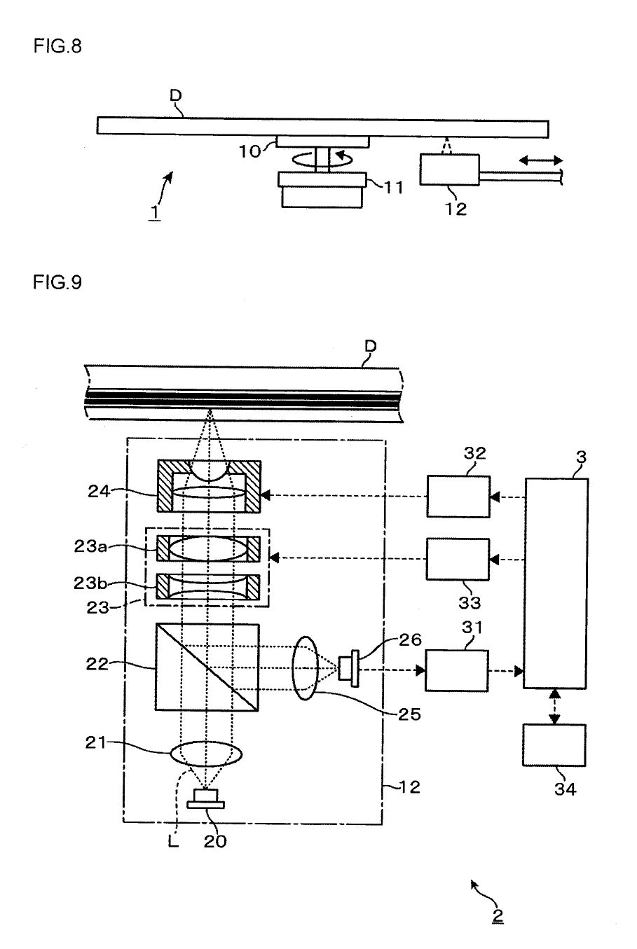

As shown schematically in FIG. 8, a recording/reproduction apparatus 1 serving as a drive apparatus for the optical disk which is one of the optical recording media includes, within a housing (not shown), a support section 10 which removably and rotatably supports an optical disk D, a spindle motor 11 which rotates the support section 10, and an optical pickup section 12 which performs scanning in a radius direction of the optical disk D, and performs recording/reproduction with optical pickup. Three types of servo control called rotation servo, focus servo, and tracking servo are performed in order to ensure favorable recording and reproduction. The focus control performed in the recording/reproduction apparatus 1 includes focus pull-in and focus jump in addition to the focus servo.

FIG. 9 is a schematic configuration diagram showing a conventional focus control apparatus 2 which performs the focus control. Typically, the focus control apparatus 2 and a tracking control apparatus which performs tracking control constitute an optical pickup apparatus. As shown in FIG. 9, the conventional focus control apparatus 2 includes a laser light source 20, a collimator lens 21, a beam splitter 22, a spherical aberration corrector 23, an objective lens 24, a condenser lens 25, and a photodetector 26, all of which constitute an optical pickup section 12 for recording/reproduction. The focus control apparatus 2 further includes a controller 3 serving as control device for performing overall control of the apparatus. In such a configuration, laser light (luminous flux L) with a predetermined wavelength (for example, 780 nm for CDs, 650 nm for DVDs, and 405 nm for next-generation DVDs such as Blu-ray disks) produced by the laser light source 20 in reproduction is collimated by the collimator lens 21, passes through the beam splitter 22 and the spherical aberration corrector 23, and is then condensed by the objective lens 24 (for example, having a numerical aperture (NA) of 0.6 or more) and irradiated to the optical disk D. The reflected light reflected by the optical disk D is condensed by the objective lens 24, passes through the spherical aberration corrector 23, and is split by the beam splitter 22. The split reflected light is condensed by the condenser lens 25 and is directed to the photodetector 26.

In the conventional focus control apparatus 2, the focus control is performed with an astigmatism method or the like by using the reflected light from the optical disk D. The focus control method utilizes the fact that the reflected light directed to the photodetector 26 forms a spot image which is not a perfect circle when the laser light is not focused. The optical signal detected by the photodetector 26 is processed (for example, by differentiation) in a signal processor 31, and a focus error is detected on the basis of the detected S-shaped waveform. When the focus error is detected, the controller 3 produces a focus control signal for canceling the focus error, and an optical pickup actuator driver 32 performs the position adjustment of the optical pickup section 12 (especially, the objective lens 24 and the spherical aberration corrector 23) in an optical axis direction, thereby adjusting the focus position in a depth direction (Z direction) of the optical disk. In FIG. 9, reference numeral 33 shows a spherical aberration correcting driver for adjusting the positions of two lenses (23a and 23b) included in the spherical aberration corrector 23 serving as a beam expander. Reference numeral 34 shows a memory for storing the data of the S-shaped waveform, the data about the spherical aberration and the like.

As described above, the focus control is performed with the astigmatism method or the like by using the reflected light from the optical disk D in the prior art. To ensure a necessary and sufficient amount of reflected light for a three-dimensionally multilayered optical disk D, an optical disk including a reflecting layer provided for each recording layer has been proposed as in Patent Document 1. When the reflecting layer is provided for each recording layer as in Patent Document 1, however, the increased number of layers unpreferably causes an increase in the cost of the medium.

An optical disk of multilayer structure ensuring a necessary and sufficient amount of reflected light without providing any reflecting layer for each recording layer has been proposed which includes alternately stacked recording layers including a recording material and gap layers (for example, air layers) made of a material having a refractive index different largely from that of the recording layer (for example, see Patent Document 2). In Patent Document 2, however, the interface of each layer has a reflectance of approximately 4%, and as the number of layers is increased, the amount of reflected light from a lower layer is reduced. For example, the amount of reflected light from the lowermost layer is approximately 0.07% when 50 layers are included, and the amount of reflected light is only 0.001% for 100 layers. The amount of reflected light is reduced as the number of layers is increased in this manner. The conventional method of performing the focus control using the reflected light from the interface of each layer has the problem in which the focus control cannot be performed substantially as the number of layers is increased.

Typically, when an increase in the number of recording layers is attempted for achieving a larger capacity, the reflectance of the interface of each layer needs to be reduced as much as possible. The reduced reflectance of the interface of each layer, however, inevitably reduces the SN ratio (signal-to-noise ratio) in the focus servo. In addition, the amount of light from the lower recording layer is significantly reduced, so that it is difficult to increase the number of recording layers.

As one of solutions to the abovementioned problems, a proposal has been made in which a recording layer containing a fluorescent material is used and the fluorescence is detected to perform focus control (for example, see Patent Document 3). In this case, while the reflectance of the interface of each layer can be reduced by using a gap layer having a refractive index different slightly from that of the recording layer, a problem arises in which the configuration of the apparatus is complicated since it is necessary to add a light source for exciting the fluorescence and a photodetector for selectively detecting the fluorescence. Furthermore, since some types of fluorescent materials reabsorb the fluorescence, the fluorescence from the recording layer in a lower layer may be absorbed by the recording layer in an upper layer and becomes feeble in the multilayer structure. In addition, other problems may occur such as blocking of recording reaction by the fluorescent material and deterioration of the fluorescent material due to repeated use.

The conventional focus control method also has a problem in which laser light for forming a recording mark in the recording layer has an output level considerably higher than the output level of laser light used in the focus control and thus it is difficult to detect a focus error during the irradiation of the laser light for recording in the astigmatism method using the reflected light. For this reason, in the prior art, a focus servo loop is typically released after focus pull-in to an intended recording layer is performed, and then the laser light for recording is irradiated. In order to perform more accurate recording reliably, however, it is desirable that the focus control can be performed during the irradiation of the laser light for recording.

[Patent Document 1] Japanese Patent Laid-Open No. 2005-122862

[Patent Document 2] Japanese Patent No. 2502884

[Patent Document 3] Japanese Patent Laid-Open No. 2006-48832

### DISCLOSURE OF THE INVENTION

### Problems to be Solved by the Invention

Problems to be solved by the present invention include the abovementioned ones, by way of example. It is thus an object of the present invention to provide a new focus control apparatus, focus control method, optical pickup apparatus, and drive apparatus capable of highly accurate focus control in an optical recording medium of multilayer structure having an interface of each layer with a reflectance reduced as much as possible, and that optical recording medium, by way of example.

It is also an object of the present invention to provide a focus control apparatus, a focus control method, an optical pickup apparatus, and a drive apparatus capable of highly accurate focus control without complicating an optical system and a detection system in an optical recording medium of multilayer structure having an interface of each layer with a reflectance reduced as much as possible, and that optical recording medium, by way of example.

It is also an object of the present invention to provide a focus control apparatus, a focus control method, an optical pickup apparatus, a drive apparatus, and an optical recording medium in which focus control can be performed during irradiation of laser light for recording, by way of example.

### Means for Solving the Problems

A focus control apparatus according to the present invention, as described in claim 1, is a focus control apparatus with optical pickup for use in an optical recording medium of multilayer structure, characterized by including laser light irradiating device including a laser light source irradiating laser light to the optical recording medium and an objective lens condensing the laser light, a photodetector detecting a change in an optical characteristic associated with multiphoton absorption caused when the laser light is condensed to at least one of recording layers, and control device for performing focus control in the optical pickup for an arbitrary recording layer of the multilayer structure in accordance with a detection result of the photodetector, wherein the laser light is irradiated at an output for recording at which a physical or chemical irreversible change occurs in the recording layer for recording information on the optical recording medium, and wherein a recording mark is formed in the recording layer, and the focus control is performed in accordance with the detection result of the optical characteristic change associated with the multiphoton absorption.

An optical pickup apparatus according to the present invention, as described in claim 12, is characterized by including the focus control apparatus according to any one of claims 1 to 11.

A drive apparatus according to the present invention, as described in claim 13, is characterized by including the optical pickup apparatus according to claim 12.

A focus control method according to the present invention, as described in claim 14, is a focus control method with optical pickup for use in an optical recording medium of multilayer structure, characterized by including irradiating laser light to a recording layer of the optical recording medium, detecting a change in an optical characteristic associated with multiphoton absorption caused when the laser light is condensed to at least one of the recording layers, and in accordance with a result of the detection, performing focus control in the optical pickup for an arbitrary recording layer of the multilayer structure, wherein, in recording information on the optical recording medium, the laser light is irradiated at an output for recording at which a physical or chemical irreversible change occurs in the recording layer of the optical recording medium to form a recording mark in the recording layer, and the focus control is performed in accordance with the detection result of the optical characteristic change associated with the multiphoton absorption.

An optical recording medium according to the present invention, as described in claim 20, is an optical recording medium of multilayer structure for use in the focus control method according to any one of claims 14 to 19, characterized by having a structure consisting of alternately stacked recording layers including a recording material and optically transparent gap layers.

A focus control method according to the present invention, as described in claim 23, is a focus control method with optical pickup in recording information on an optical recording medium, characterized by including irradiating laser light for recording at an output at which a physical or chemical irreversible change occurs in a recording layer of the optical recording medium, condensing the laser light to at least one of recording layers to form a recording mark, detecting a change in an optical characteristic associated with multiphoton absorption caused when the laser light is condensed to the recording layer, and in accordance with a result of the detection, performing focus control in the optical pickup.

A focus control method according to the present invention, as described in claim 24, is a focus control method with optical pickup for use in an optical recording medium, characterized by including the step of irradiating laser light at an output at which any physical or chemical irreversible change does not occur in a recording layer of the optical recording medium, and performing focus pull-in in accordance with a detection result of a change in an optical characteristic associated with the multiphoton absorption, and the step of irradiating the laser light to the recording layer subjected to the focus pull-in at an output at which a physical or chemical irreversible change occurs and forming a recording mark in the recording layer, and performing focus servo in accordance with a detection result of the optical characteristic change associated with the multiphoton absorption.

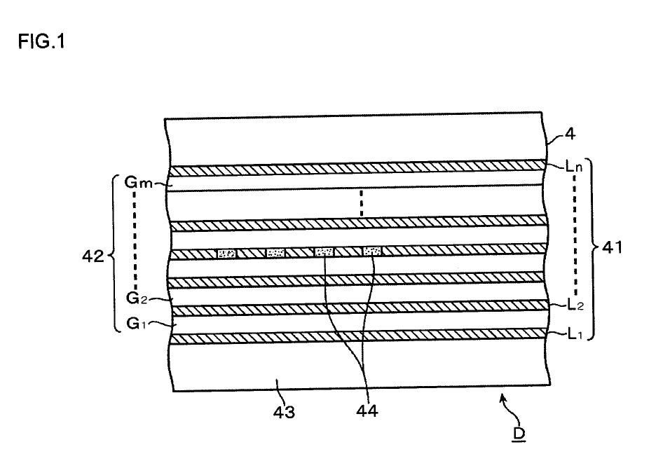

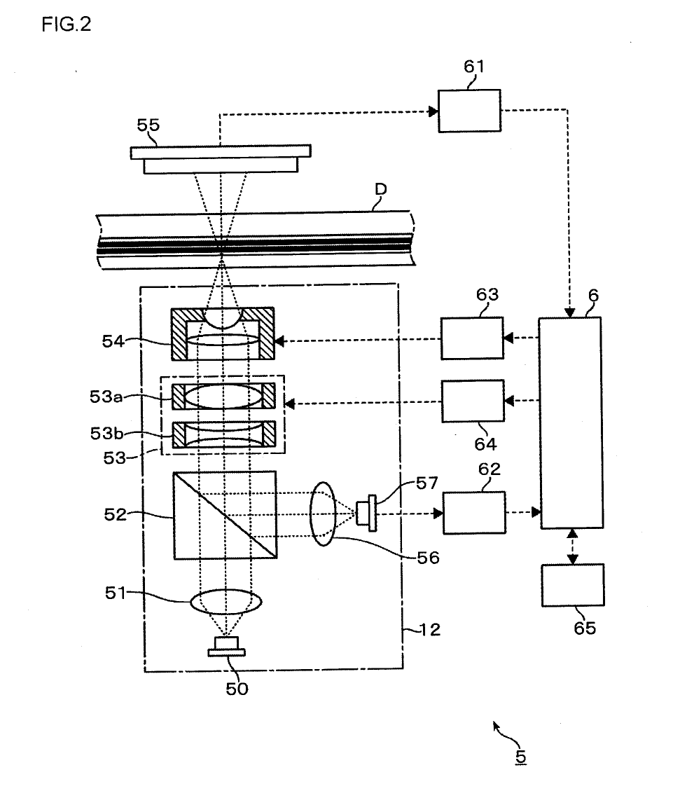

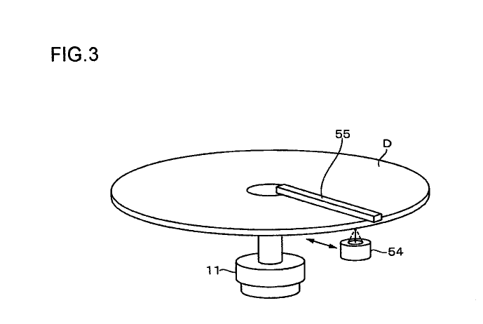

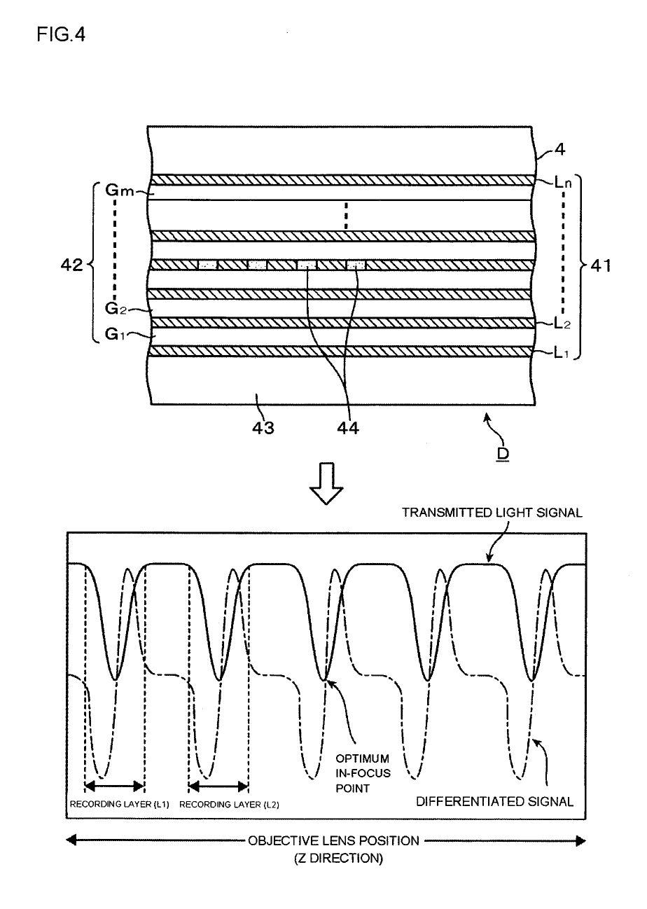

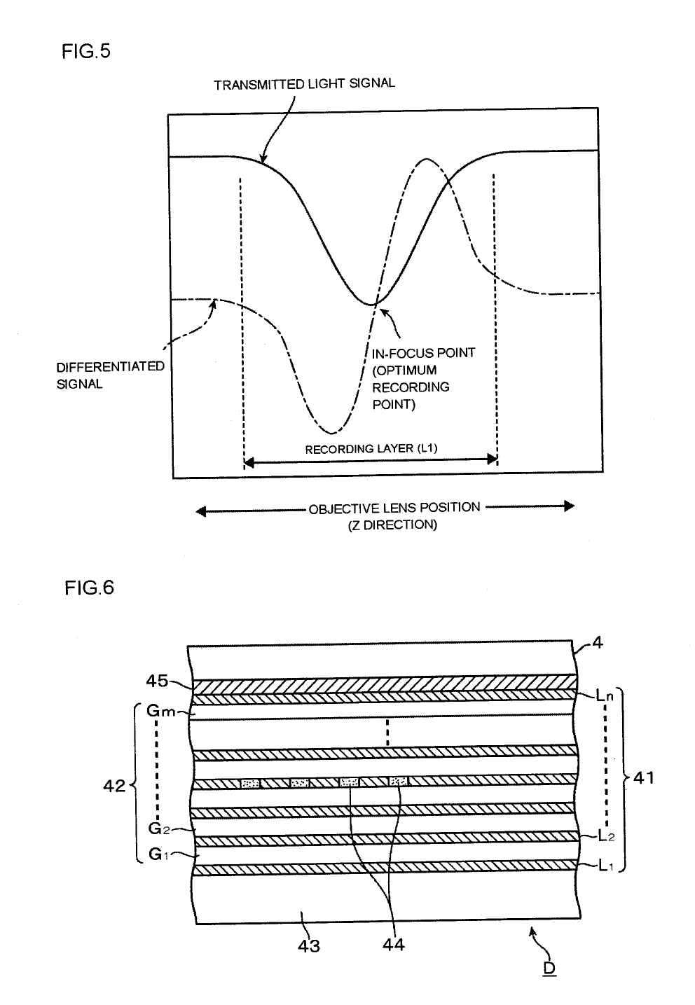

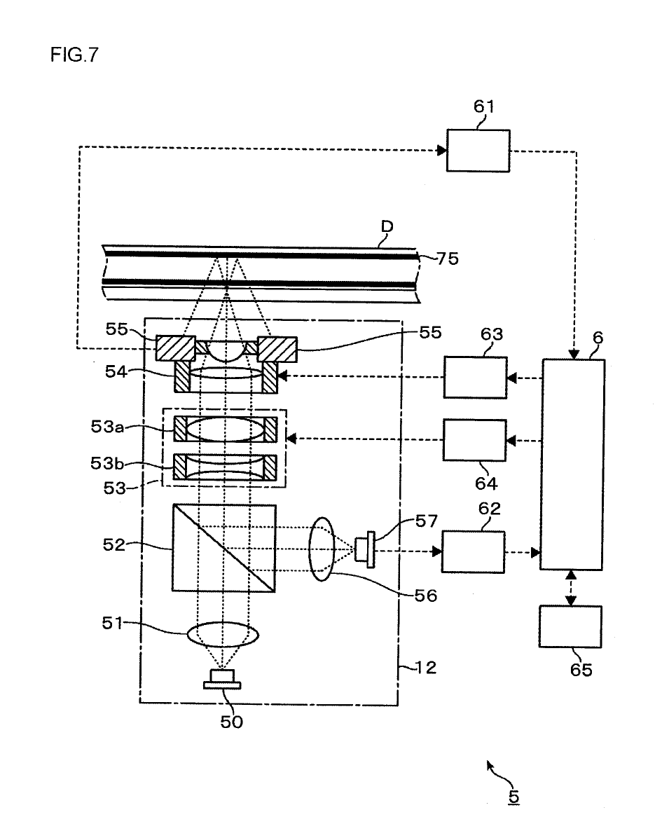

### BRIEF DESCRIPTION OF DRAWINGS

[FIG. 1] A diagram showing an optical disk for use in a focus control method according to Embodiment 1 of the present invention.

[FIG. 2] A diagram showing a focus control apparatus according to Embodiment 1 of the present invention.

[FIG. 3] A diagram showing a variation of a first photodetector of the focus control apparatus.

[FIG. 4] A diagram schematically showing a signal detected by the focus control apparatus.

[FIG. 5] A diagram schematically showing a signal detected by the focus control apparatus.

[FIG. 6] A diagram showing an optical disk for use in a focus control method according to Embodiment 2 of the present invention.

[FIG. 7] A diagram showing a focus control apparatus according to Embodiment 2 of the present invention.

[FIG. 8] A diagram for explaining a conventional reproduction/recording apparatus for an optical disk.

### DESCRIPTION OF REFERENCE NUMERALS

12 OPTICAL PICKUP SECTION

D OPTICAL DISK

41 RECORDING LAYER (L1 to Ln)

42 GAP LAYER (G1 to Gm)

45 REFLECTING LAYER

5 FOCUS CONTROL APPARATUS

50 LASER LIGHT SOURCE

54 OBJECTIVE LENS

55 FIRST PHOTODETECTOR

6 CONTROLLER

61 FIRST SIGNAL PROCESSOR

63 OPTICAL PICKUP ACTUATOR DRIVER

### BEST MODE FOR CARRYING OUT THE INVENTION

As apparent from embodiments later described, a focus control method according to the present invention is a new focus control method which includes detecting a change in optical characteristics (for example, attenuation of transmittance, occurrence of fluorescence or the like) resulting from absorption of two or more photons by a material (hereinafter referred to as “multiphoton absorption”) and using the detection result in focus control for an optical recording medium. The multiphoton absorption may refer to either of the case where energy of photons of different frequencies is simultaneously absorbed or the case where electrons or molecules which are in a high energy state after absorption of photons absorb other photons (which may have different frequencies). As described earlier, in the conventional focus control method using the reflected light, the control cannot be performed substantially as the number of the layers is increased. The difficulty in the focus control may be one of factors responsible for the multilayered optical disk of 100 layers or more not becoming commercially practical although the multilayering is technically possible. Consequently, the focus control method according to the present invention capable of solving the problem in the prior art can be considered as a promising technology which is expected to be a standard for focus control used in the optical disk of multilayer structure in the future.

Preferred embodiments for realizing the new focus control method according to the present invention will hereinafter be described in detail with reference to the accompanying drawings. However, the technical scope of the present invention should not be interpreted as limited by the embodiments described below.

### EMBODIMENT 1

First, an optical recording medium of multilayer structure for use in the focus control method according to Embodiment 1 of the present invention will be described by taking an optical disk D as an example. However, the present embodiment is not limited to the optical disk but is applicable to other types of optical recording media such as an optical card memory. FIG. 1 is a diagram schematically showing a portion of the multilayer structure of the optical disk D. As shown in FIG. 1, the optical disk D has the multilayer structure in which recording layers 41 (L1, L2, . . . , Ln) including a recording material and gap layers 42 (G1, G2, . . . , Gm) made of an optically transparent material are alternately stacked on one surface of a transparent resin substrate 4 and finally a transparent cover 43 is formed. The optical disk D of the present embodiment has the configuration having no reflecting layer as in the prior art at the interface between the recording layer 41 and the gap layer 42, which reduces the reflectance of the interface of each layer. In addition, the recording layer 41 and the gap layer 42 are provided by using materials having refractive indexes different slightly from each other, so that the reflectance of the interface of each layer is further reduced. Such a multilayer structure allows optical access to the recording layer (Ln) in the lowermost layer even when the number of layers is increased. In order to enable separation of focus error signals between the layers, however, the recording layer 41 is made of a material which undergoes multiphoton absorption at least more easily than the material of the gap layer 42. Thus, the multilayer structure of the optical disk D shown in FIG. 1 has the characteristic in which it has almost no boundaries between the layers from the optical viewpoint and passes laser light therethrough but it has boundaries between the layers from the viewpoint of photon absorption characteristics. In FIG. 1, reference numeral 44 schematically shows a recording mark which has a changed refractive index.

For the optical disk D for recording and reproduction, an example of the recording material is a photo-inducing refractive index changing material which undergoes a physically or chemically irreversible change to cause a change in refractive index depending on the intensity of light. As the light-inducing refractive index changing material, it is possible to use a multiphoton material which is excited through a multiphoton absorption process and then has a changed refractive index due to a physically or chemically irreversible change, such as metal free tetraphenylporphine, halogenated anthracene, CdS, GeO₂ doped glass, and chalcogen glass, for example. It is also possible to use a phase changing material such as SbTe, an organic dye material, or a photosensitive material such as cyclized polyisoprene+bisazido, methyl polymethacrylate, and GeO₂ doped glass. The multiphoton absorption is a phenomenon which may occur in almost all of known recording materials, although the absorption characteristics vary with materials. Thus, in the present embodiment in which the phenomenon is used to perform the focus control, the materials of the recording layer 41 and the gap layer 42 are not limited particularly, and any of known materials used for the optical disk D can be used, as long as the multilayer structure of the optical disk D satisfies the abovementioned conditions.

Next, a focus control apparatus of the present embodiment will be described with reference to FIG. 2. As shown in FIG. 2, a focus control apparatus 5 of the present embodiment includes a laser light source 50 which produces laser light for irradiation to the optical disk D, a collimator lens 51, a beam splitter 52 which is a spectroscope, a spherical aberration corrector 53 which serves as an aberration corrector, an objective lens 54, a first photodetector 55 for detecting an optical change associated with the multiphoton absorption, a condenser lens 56, and a second photodetector 57 which detects a read RF signal in reproduction, all of which constitute an optical pickup section 12 for recording/reproduction.

The focus control apparatus 5 also includes a controller 6 which serves as control device, a first signal processor 61 which processes a signal detected by the first photodetector 55, and a second signal processor 62 which processes a signal detected by the second photodetector 57. The controller 6 performs the overall control operation of the apparatus including rotation control, focus control, and tracking control of the optical disk D. The controller 6 has, as one of the focus control functions, the function of producing each focus control signal for performing focus pull-in to an arbitrary recording layer 41, focus servo, and focus jump of moving the focus position to another recording layer 41 based on the optical signal detected by the first photodetector 55. An optical pickup actuator driver 63 performs the position adjustment of the optical pickup section 12 (especially, the objective lens 54 and the spherical aberration corrector 53) in an optical axis direction in accordance with the focus signal transmitted from the controller 6, thereby adjusting the focus position in a depth direction (Z direction) of the optical disk. A spherical aberration correcting driver 64 is formed to adjust the positions of two lenses (53a and 53b) of the spherical aberration corrector 53 which is a beam expander in accordance with a spherical aberration correcting signal transmitted from the controller 6. A memory 65 is an example of storage device for storing information of S-shaped waveform, later described, information about aberration correction or the like.

The laser light source 50 is only required to irradiate laser light at an output value (first output value) at which the multiphoton absorption is induced in the recording material contained in the recording layer 41 but any physical or chemical irreversible change does not occur in the recording layer 41, that is, at an output value which is not high enough for recording. The laser light source preferably generates variable outputs to enable irradiation of laser light at an output value (second output value) at which a physical or chemical irreversible change occurs in the recording layer 41, that is, at an output value at which the recording mark (44) can be formed for performing the recording. An example of such a laser light source is a pulse laser light source, and a femtosecond pulse laser light source is preferably used. It is possible to use a laser light source having the output value control function of providing at least binary output values at the first output value and the second output value. The laser light source capable of the output control described above may be of a type of controlling outputs with electric current driving as in a semiconductor laser or a type of controlling outputs with an external modulator.

For the abovementioned reasons, the focus control method of the present embodiment can be used for any of known materials used in the recording layer and the gap layer. Thus, the specific first and second output values (that is, the pulse width and the light intensity) of irradiated laser light are preferably determined depending on the type of the selected material.

The collimator lens 51, the beam splitter 52, the spherical aberration corrector 53, the objective lens 54, the condenser lens 56, the second photodetector 57 for detecting the read RF signal in reproduction, and the second signal processor 62 can be provided by using the components similar to those in the prior art, and the processing operation thereof can also be performed similarly to the prior art. The configuration generally similar to that of the conventional optical system and detection system is employed in this manner. In other words, the focus control method of the present embodiment is a method which can be realized without complicating the optical system and the detection system as compared with the conventional configuration.

The first photodetector 55 is placed at a position opposite to the objective lens 54 with the optical disk D interposed between them. The present embodiment is an embodiment in which the focus control is performed by taking advantage of attenuation of transmittance which is one of optical characteristics associated with the multiphoton absorption. Thus, the first photodetector 55 can have a light receiving section (for example, a light receiving element such as a photodiode) which receives the laser light (transmitted light) transmitted through the optical disk D. The light detected by the first photodetector 55 is converted into an electric signal in accordance with the light intensity and is transmitted to the first signal processor 61. The first photodetector 55 shown in FIG. 2 is formed to be moved for scanning in synchronization with the objective lens 54 (for example, the pickup section 12) in a radius direction of the optical disk by scanning device (not shown). As shown in FIG. 3, the first photodetector 55 may be formed in an elongated band shape along the scanning path of the objective lens 54 (for example, the radius direction for the optical disk D). In this case, the first photodetector 55 is fixedly placed, and the scanning device for scanning with the first photodetector 55 in synchronization with the objective lens 54 can be omitted.

The first signal processor 61 processes the electrical signal from the first photodetector 55. Specifically, the processor 61 differentiates the optical signal detected by the first photodetector 55 to detect a so-called S-shaped waveform and transmits the detection result to the controller 6. The controller 6 has the processing function of detecting the position (optical length) of the optimum focal point of the laser light based on the detected S-shaped waveform, producing a focus control signal for adjusting the optical pickup section 12 (especially the objective lens 54 and the aberration corrector 53) such that the condensing point of the laser light is located at the optimum focal point, and transmitting the produced focus control signal to the optical pickup actuator driver 63. The optical pickup actuator driver 63 drives the optical pickup section 12 in the optical axis direction in accordance with the transmitted focus control signal.

For further understanding of the focus control method according to the present embodiment, the method of detecting the optimum focal point by using the attenuation of transmittance associated with the multiphoton absorption will be described in detail with reference to FIG. 4. The multiphoton absorption has the characteristic in which it occurs only near the focal point of laser light regardless of the number of absorbed photons as in two-photon absorption or three-photon absorption. The attenuation of transmittance associated with the multiphoton absorption also has the characteristic in which the attenuation occurs only near the focal point of laser light, although the attenuation factor depends on the light intensity. When attention is paid to this characteristic, the optical disk is scanned in the depth direction (Z direction) with the condensing point of laser light, for example, to enable detection of a waveform of transmitted light having separated peaks of attenuation in the respective recording layers as shown schematically in FIG. 4. The scanning with the condensing point may be performed in all of the recording layers (L1 to Ln) or may be performed only in some of the recording layers. FIG. 4 schematically shows the waveform in the case of two-photon absorption, by way of example. Since the waveform of transmitted light having the separated peaks of attenuation in the respective recording layers is obtained in this manner, the waveform can be differentiated to detect the so-called S-shaped waveform as a focus error signal. The zero crossing point of the S-shaped waveform corresponds to the attenuation peak, and this position serves as the optimum focal point in each recording layer. The condensing point is set to be located at the detected optimum focal point to allow accurate focusing for an arbitrary recording layer. Since the attenuation factor of transmitted light due to the multiphoton absorption depends on the light intensity, the laser light output can be changed to adjust the magnitude of the attenuation peak, so that the favorable S-shaped waveform can be detected.

Next, the operation of the focus control apparatus 5 described above will be explained. Description is made herein of a series of operations including focus pull-in to an arbitrary recording layer (for example, the recording layer L1) of the optical disk D, formation of the recording mark (44) in the recording layer L1 to record information, and reproduction of the recorded information, and the operation of focus jump to the recording layer L2, by way of example . However, the present embodiment relates to the new focus control method, and any known method can be used for the rotation control and the tracking control. Thus, detailed description of the rotation control and the tracking control is omitted in the following description.

### Focus Pull-In

First, when the optical disk D is loaded on the support section 10 of the drive apparatus as shown in FIG. 8, the spindle motor 11 is driven to rotate the optical disk D, and the optical pickup section 12 is moved toward the inner radius below the optical disk D. Then, laser light is irradiated at the first output value by laser light irradiating device including the laser light source 50 and the objective lens 54, and the optical pickup section 12 (especially the objective lens 54 and the spherical aberration corrector 53) is moved in the optical axis direction to scan the optical disk D in the depth direction (Z direction) with the condensing point. The transmitted light is detected by the first photodetector 55 and is differentiated by the first signal processor 61 to allow the detection of the S-shaped waveform having the separated focus error signals in the respective recording layers (L1 to Ln) as shown in FIG. 4 by way of example, and from the zero crossing point of the waveform, the optical length of the optimum focal point of each recording layer (L1 to Ln) is determined. In addition, the interlayer distance is determined by using the refractive index of the gap layer 42. The obtained information of the S-shaped waveform and the interlayer distance is stored in the memory 65.

Next, the position of the optical pickup section 12 is adjusted by the optical pickup actuator driver 63 based on the information of the optical length of the optimum focal point and the interlayer distance to perform focus pull-in to the intended recording layer L1. When the focus pull-in is completed, tracking pull-in is performed, and the position correction of the two lenses (53a and 53b) of the spherical aberration corrector 53 serving as the beam expander is performed to correct the spherical aberration optimally.

### Recording

Once the operation from the focus pull-in to the spherical aberration correction is completed for the recording layer L1 as described above, laser light is irradiated at the second output value for forming the recording mark to form the recording mark (44) in the recording layer L1 to record information on the optical disk D. While the focus servo loop is released at this point in the conventional method using reflected light, the focus servo loop can be operative during the irradiation of the laser light for recording in the present embodiment. Specifically, when the high-output laser light for recording is irradiated, the refractive index of the recording layer is changed to cause a change in the waveform of the transmitted light, but the attenuation peak of transmittance due to the multiphoton absorption can be detected, and the focus servo can be performed for the optimum focal point (that is, the optimum recording point) shown schematically in FIG. 5 to ensure more accurate recording. However, the focus servo is not necessarily needed in the recording, and the focus servo loop may be released after the focus pull-in is completed. Alternatively, only the detection of a focus error may be performed.

### Reproduction

In reproducing the optical disk D on which the recording has been performed as described above, or the optical disk on which recording has already been performed, focus pull-in can also be performed to an arbitrary recording layer in a manner similar to the abovementioned one. Once the focus pull-in is completed, tracking pull-in and spherical aberration correction are performed. While the attenuation of transmitted light in the recording layer intended for reproduction is detected, focus servo is performed in accordance with a focus error signal similar to that in FIG. 5, and tracking servo is performed with a tracking error signal, laser light for reproduction is irradiated. Then, a read RF signal is detected by the second photodetector 57 and is processed by the second signal processor 62 to reproduce the information. The laser light for reproduction may be irradiated from a different emitting section of the laser light source, or a laser light source (not shown) different from the abovementioned laser light source may be used.

Since the recording layer 41 of the optical disk having the recording mark formed thereon has a changed refractive index, the focus control can be performed by the astigmatism method or a knife edge method as in the prior art. While the laser light for reproduction is irradiated and the read RF signal is detected by the second photodetector 57 to perform the reproduction, the focus servo may be performed in a manner similar to that of the prior art by detecting a focus error with the astigmatism method or the like using reflected light detected by the second photodetector 57.

### Focus Jump

For performing the focus jump from the recording layer to another recording layer (for example, from the recording layers L1 to L2), the focus servo and the tracking servo for the recording layer L1 are released first. Next, the information of the interlayer distance stored in the memory 65 is used to estimate a correction value of spherical aberration for the recording layer L2, and the estimated value is used to adjust the position of the two lenses (53a and 53b) of the spherical aberration corrector 53 in advance. Then, the optical pickup section 12 is moved in the optical axis direction by the optical pickup actuator driver 63 to perform the focus jump to the recording layer L2. As in the recording layer L1, focus pull-in to the recording layer L2 is performed on the basis of the information of the optical length of the optimum focal point and the interlayer distance. Once the focus pull-in is completed, tracking pull-in is performed, and adjustment is performed to achieve optimum correction of spherical aberration, thereby completing the focus jump.

As described above, according to the focus control method of the present embodiment, attention is paid to the characteristic in which the multiphoton absorption occurs only near the focal point of laser light, and the focus control is performed by detecting the attenuation of transmittance associated with the multiphoton absorption found when the laser light is condensed to at least one of the recording layers 41. This enables the detection of the focus error signals separated in the respective recording layers in the optical disk D of multilayer structure having the interface of each layer with a low reflectance. When the focus control is performed in accordance with the detected focus error signal, accurate focus control can be performed for an arbitrary recording layer (L1 to Ln).

In addition, according to the focus control method of the present embodiment, the laser light is irradiated at the output at which any physical or chemical irreversible change does not occur in the recording layer, so that the focus control can be performed while preventing occurrence of an unintentional change in the refractive index of the recording layer. In other words, since the output is set at the level which is not high enough for recording, the change in optical characteristic due to the multiphoton absorption utilized in the present embodiment is the reversible phenomenon in which the transmittance is attenuated when the laser light is condensed and the original state is recovered when the condensing is canceled. This can realize the new focus control method using the multiphoton absorption.

According to the focus control method of the present embodiment, since any special material is not used for the focus control such as the fluorescent dye as in Patent Document 3, the focus control method has general versatility of applicability to the existing optical disk D. Additionally, when the laser light source for focusing doubles as the laser light source for recording, it is only necessary to add the detection system for detecting the transmitted light (the first photodetector 55 and the second photodetector 61). As a result, the accurate focus control can be performed for the optical disk of multilayer structure having the interface of each layer with a low reflectance without complicating the optical system and the detection system as compared with the conventional configuration.

Furthermore, according to the focus control method of the present embodiment, since the attenuation of transmittance due to the multiphoton absorption is used in the focus control, the focus error signal can be detected during the recording performed through the irradiation of the high-output laser light for recording. This eliminates the need to release the focus servo loop as in the prior art and allows the focus servo to be performed during the recording. As a result, the focus control method of the present embodiment enables more accurate recording as compared with the prior art. The focus control method of the present embodiment capable of such accurate recording is applicable to an optical disk having a reflecting layer in each layer and a conventional optical disk including recording layers of less than 10 layers, in addition to the optical disk of multilayer structure shown in FIG. 1.

### EMBODIMENT 2

Next, Embodiment 2 of the present invention will be described. In a focus control method according to the present embodiment, attenuation of transmittance due to multiphoton absorption is detected as in Embodiment 1, but transmitted light is reflected by an optical disk D and the reflected light is detected. Thus, components identical to those in Embodiment 1 are designated with the same reference numerals and detailed description thereof is omitted.

FIG. 6 is a diagram schematically showing a portion of a multilayer structure of the optical disk D used in the present embodiment. As shown in FIG. 6, the optical disk D is formed to have a reflecting layer 45 between a transparent resin substrate 4 and the multilayer structure consisting of recording layers and gap layers. The material of the reflecting layer 45 is not limited particularly, and a known reflecting material may be used. In this manner, the optical disk D used in the present embodiment is formed to have the reflecting layer 45 on a surface opposite to a surface upon which laser light is incident. Since no reflecting layer is provided for each layer, an increase in medium cost is suppressed.

FIG. 7 is a schematic configuration diagram of a focus control apparatus 5 to which the present embodiment is applied. As shown in FIG. 7, the focus control apparatus 5 of the present embodiment includes a first photodetector 55 for detecting attenuation of transmittance due to multiphoton absorption placed closer to an objective lens 54 to detect transmitted light passed through the multilayer structure and reflected by the reflecting layer 45. In this case, the first photodetector 55 is preferably placed around the objective lens 54 so as to allow the reliable detection of the reflected transmitted light. In this case, alight receiving section (for example, alight receiving element such as a photodiode) of the first photodetector 55 is preferably placed on the entire periphery of the objective lens 54, but may be placed partially. More preferably, the first photodetector 55 is provided for a housing which holds the objective lens 54.

The attenuation of transmittance due to the multiphoton absorption can also be detected in the abovementioned configuration, and focus control similar to that in Embodiment 1 can be performed. In addition, the configuration of the present embodiment eliminates the need of the space for placing the first photodetector 55 at the position opposite to the objective lens 54, so that the apparatus can be advantageously reduced in size.

### EMBODIMENT 3

As a variation of Embodiments 1 and 2, the first photodetector 55 can double as the second photodetector 62 which detects the read RF signal. Similarly, the first signal processor 61 can double as the second signal processor 62. Such a configuration also enables the detection of attenuation of transmittance due to multiphoton absorption, and focus control similar to those in Embodiments 1 and 2 can be performed. Furthermore, the configuration of the present embodiment can realize the focus control more reliably for the optical disk D of multilayer structure having the interface of each interface with a low reflectance without complicating the optical system and the detection system.

Embodiments 1 to 3 have been described in which the attenuation of transmittance due to multiphoton absorption is detected to perform the focus control. However, the present invention is not limited to the detection of the attenuation of transmittance, and fluorescence resulting from multiphoton absorption may be detected as a change in the optical characteristic. The fluorescence has the characteristic in which it is produced only near the focal point of laser light similarly to the attenuation of transmittance. The fluorescence can be detected by the first photodetector 55 to detect the separated peaks of the fluorescence in the respective layers similarly to the attenuation of transmittance. The detected fluorescent signal can be differentiated to obtain an S-shaped waveform similar to that in FIG. 4, and the S-shaped waveform can be used to perform focus control similar to that in Embodiments 1 to 3. For detecting the fluorescence, an optical filter is preferably provided for separating the fluorescence in addition to the configurations in FIGS. 2 and 7.

While some embodiments of the present invention have been described, it is apparent to those skilled in the art that many modifications and variations may be made without departing from the spirit or scope of the present invention, and those modifications and variations are included in the technical scope of the present invention.

1-24. (canceled)

25. A focus control apparatus with optical pickup for use in an optical recording medium of multilayer structure, comprising:
laser light irradiating device including a laser light source irradiating laser light to the optical recording medium and an objective lens condensing the laser light;
a photodetector detecting a change in an optical characteristic associated with multiphoton absorption caused when the laser light is condensed to at least one of recording layers; and
control device for performing focus control in the optical pickup for an arbitrary recording layer of the multilayer structure in accordance with a detection result of the photodetector,
wherein the laser light is irradiated at an output for recording at which a physical or chemical irreversible change occurs in the recording layer for recording information on the optical recording medium, and
wherein a recording mark is formed in the recording layer, and the focus control is performed in accordance with the detection result of the optical characteristic change associated with the multiphoton absorption.

26. The focus control apparatus according to claim 25, wherein the laser light is irradiated at an output for reproduction at which any physical or chemical irreversible change does not occur in the recording layer for reproducing information on the optical recording medium, and
wherein the focus control is performed in accordance with the detection result of the optical characteristic change associated with the multiphoton absorption.

27. The focus control apparatus according to claim 26, wherein the laser light source is a laser light source having an output value control function of providing at least binary output values such that the laser light can be irradiated at an output value at which a physical or chemical irreversible change occurs in the recording layer and at an output value at which any physical or chemical irreversible change does not occur in the recording layer.

28. The focus control apparatus according to claim 25, wherein the optical characteristic change is attenuation of transmittance of the laser light due to the multiphoton absorption.

29. The focus control apparatus according to claim 25, wherein the optical characteristic change is occurrence of fluorescence due to the multiphoton absorption.

30. The focus control apparatus according to claim 25, wherein the photodetector is placed at a position opposite to the objective lens with the optical recording medium interposed between them, the focus control apparatus further comprising scanning device for scanning with the photodetector in synchronization with the objective lens.

31. The focus control apparatus according to claim 25, wherein the photodetector is placed at a position opposite to the objective lens with the optical recording medium interposed between them and has an elongated band shape formed along a scanning path of the objective lens.

32. The focus control apparatus according to claim 25, wherein the photodetector is placed around the objective lens, the focus control apparatus further comprising scanning device for scanning with the objective lens and the photodetector in unison.

33. The focus control apparatus according to claim 25, wherein the photodetector doubles as a photodetector detecting a read RF signal in reproduction.

34. An optical pickup apparatus comprising the focus control apparatus according to claim 25.

35. A drive apparatus for an optical recording medium comprising the optical pickup apparatus according to claim 34.

36. A focus control method with optical pickup for use in an optical recording medium of multilayer structure, comprising:
irradiating laser light to a recording layer of the optical recording medium, detecting a change in an optical characteristic associated with multiphoton absorption caused when the laser light is condensed to at least one of the recording layers, and in accordance with a result of the detection, performing focus control in the optical pickup for an arbitrary recording layer of the multilayer structure,
wherein, in recording information on the optical recording medium, the laser light is irradiated at an output for recording at which a physical or chemical irreversible change occurs in the recording layer of the optical recording medium to form a recording mark in the recording layer, and the focus control is performed in accordance with the detection result of the optical characteristic change associated with the multiphoton absorption.

37. The focus control method according to claim 36, wherein, in reproducing information on the optical recording medium, the laser light is irradiated at an output at which any physical or chemical irreversible change does not occur in the recording layer of the optical recording medium, and the focus control is performed in accordance with the detection result of the optical characteristic change associated with the multiphoton absorption.

38. The focus control method according to claim 36, wherein the optical characteristic change is attenuation of transmittance of the laser light due to the multiphoton absorption.

39. The focus control method according to claim 36, wherein the optical characteristic change is occurrence of fluorescence due to the multiphoton absorption.

40. An optical recording medium of multilayer structure for use in the focus control method according to claim 36, having a structure consisting of alternately stacked recording layers including a recording material and optically transparent gap layers.

41. The optical recording medium according to claim 20, wherein the optical recording medium has no reflecting layer at an interface between the recording layer and the gap layer.

42. The optical recording medium according to claim 40, wherein, when the detected optical characteristic change is attenuation of transmittance of the laser light due to the multiphoton absorption, the multilayer structure of the optical recording medium has a reflecting layer on a surface opposite to a surface upon which the laser light is incident.

43. A focus control method with optical pickup in recording information on an optical recording medium, comprising:
irradiating laser light for recording at an output at which a physical or chemical irreversible change occurs in a recording layer of the optical recording medium, condensing the laser light to at least one of recording layers to form a recording mark, detecting a change in an optical characteristic associated with multiphoton absorption caused when the laser light is condensed to the recording layer, and in accordance with a result of the detection, performing focus control in the optical pickup.

44. A focus control method with optical pickup for use in an optical recording medium, comprising:
irradiating laser light at an output at which any physical or chemical irreversible change does not occur in a recording layer of the optical recording medium, and performing focus pull-in in accordance with a detection result of a change in an optical characteristic associated with multiphoton absorption, and
irradiating the laser light to the recording layer subjected to the focus pull-in at an output at which a physical or chemical irreversible change occurs and forming a recording mark in the recording layer, and performing focus servo in accordance with a detection result of the optical characteristic change associated with the multiphoton absorption.
